(19) United States
(12) Patent Application Publication
(10) Pub. No.: US 2018/0005135 A1
(43) Pub. Date: Jan. 4, 2018

(54) EMBEDDED SENSOR MODEL

(71) Applicant: Intel Corporation, Santa Clara, CA (US)

(72) Inventors: Luis Sergio Kida, Beaverton, OR (US); Christopher Boyd Rogers, Beaverton, OR (US)

(21) Appl. No.: 15/200,478

(22) Filed: Jul. 1, 2016

(51) Int. Cl. G06N 99/00; G06N 5/04; G06F 1/16

(52) U.S. Cl. CPC G06N 99/005; G06F 1/163; G06N 5/04

(57) ABSTRACT

System and techniques for an embedded sensor model are described herein. A message that includes a model identifier field, a performance label, a sensor set, and a first user identification field containing a user identification is obtained. A set of feedback packages is obtained. A feedback package includes a value and indicates the user identification. Feedback package values are aggregated to create a weight for the user identification. A training set is applied to a model to create a new model. This includes modifying model training with respect to the sensor set based on the performance label and the weight. The new model may then be transmitted to a user device. The new model providing a sensor classifier for a sensor monitoring user activity.

### TECHNICAL FIELD

Embodiments described herein generally relate to fitness devices and more specifically to embedded sensor models.

### BACKGROUND

The convergence of the Quantified Self movement, (connected) wearable devices, activity trackers, mobile applications, social networking, and gamification have changed the dynamics of sports and fitness. Fitness is no longer a private endeavor. Today's professional or amateur athlete wants her activity recognized and measured by a wearable fitness device that is connected to report achievements to others, eliciting recognition and support.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for an embedded sensor model, according to an embodiment.

FIG. 2 illustrates a block diagram of an example of a system for an embedded sensor model, according to an embodiment.

FIG. 3 illustrates a flow diagram of an example of a method for an embedded sensor model, according to an embodiment.

FIG. 4 illustrates a flow diagram of an example of a method for an embedded sensor model, according to an embodiment.

FIG. 5 illustrates a flow diagram of an example of a method for an embedded sensor model, according to an embodiment.

FIG. 6 is a block diagram illustrating an example of a machine upon which one or more embodiments may be implemented.

### DETAILED DESCRIPTION

A limiting factor to increase consumer adoption of wearable computing devices is the capability of such devices to accurately perceive a variety of different activities. This perception may be accomplished through a model. As used herein, a model is a transformation from input data to output data. For example, if an accelerometer measures a certain frequency of bumps of a certain magnitude, the model will accept that data and produce a determination that a user is running. Models are generally implemented with a variety of machine learning and other techniques, such as artificial neural networks (ANNs), support vector machines (SVM), statistical models, among others.

Current activity models are specific to a few activities. A common user complaint to existing devices is that the models embedded in the device are inaccurate for some users or, under certain conditions, that the devices don't give credit to an activity (e.g. the device doesn't recognize badminton well), that the devices misrecognize an activity (e.g. the device measures leg shaking as running), or that the devices allow “cheating” (e.g. cheater will move her arm or leave a device on top of a clothes dryer and claim credit for “a long run”). The creation of general and robust models—models that are accurate to a wide population and under a variety of conditions and activities is difficult, expensive and time consuming.

Machine learning is a term that encompasses a family of techniques in which the system itself incorporates data to provide outcomes without human intervention. These techniques may be applied to create activity models, reducing errors in human designed models that identify rules governing an activity being modeled. Traditional application of machine learning techniques still involves significant time and effort to develop a general and robust model. Machine learning techniques often require large data collection efforts to represent a desired model through examples and counter examples under all operational conditions and for all types of subjects that the model is intended to address. Further, even if a model developer intends to invest the time and money to account for all possible conditions, nature has a wider variety of situations than a developer is likely to consider.

Activity model developers typically attempt a first model that will then be updated over time. Current model update flow typically involves a dissociation between users and model developers. Generally, users report their experience with the model in an unorganized manner, such as in review sites, social networks, or directly to the device vendor. The developer must pull the information from all these disparate sources, evaluate the feedback provided, reproduce results, and work with experts in the activity domain (e.g. a running coach for a running wrist device) to collect data and update the model.

After gathering feedback from users, the developer may release an updated activity model hoping the users will use this model and it will improve the feedback. This process may iterate, the developer continuing to gather feedback for improved activity models, until a desired result is achieved. Often, the developer doesn't have the details of operational conditions applicable to each piece of feedback, such as which version of the activity model is causing complaints. Further, the developer often has no access to sensor data from the various devices that are the source of the complaints. The cost and time to collect sufficient data to create activity models that apply to a large number of diverse customers and is accurate under real-life conditions is substantial and one of the most important limiting factors slowing the growth the consumer wearable device adoption and continued use.

To address the problems of data gathering for activity model development and improving activity models used in end user devices, an embedded sensor model system is herein described. The system employs an entry and rating mechanism to collect user performance labels of model performance, as well as feedback packages of other users with respect to the submitting user. The combination of these two elements permits model training on submitted sensor data that is tempered by the trustworthiness of the sensor data's submitter as judged by other community users. As new models are trained, they may be delivered to user devices, completing a feedback cycle that constantly improves the embedded sensor models in the users' devices.

The system makes acceptable to customers the deployment of simple models that have classification accuracy limitations on activity type and operational conditions via a continuous upgrade path from user qualitative feedback and sensor data. This feedback and re-release cycle is enabled via the platform by gamification (e.g., motivating user submission and response to receive competitive rewards such as prestige) allowing the customer to provide examples of correct and incorrect classifications to the developers for them to improve and distribute improved models.

Thus, developers may initiate a new product with a “good enough” model based on a smaller data collection, knowing that the activity data and thus models will improve as user participation in the feedback cycle is enabled. This technique will reduce upfront resources (e.g., time, costs, etc.) allowing for shorter development time for more numerous activity models. Lowering development resource burn enables smaller (e.g., start-up) entities to release activity trackers for a greater variety of activities.

In addition to lowering the cost and time of activity model development, starting from a “bad model” of low accuracy to a “good model” of high accuracy and/or specificity to a particular operational condition or activity; the engagement of users in the improvement process may garner loyalty and ongoing participation. That is, evolving the activity models itself is a motivator for participation and loyalty to the social network and device platform because participating in the social network to report deficiencies in the device/model provides a constructive and responsive platform for users to vent frustration and improve the experience. In the context of gamification, even misclassifications motivate the community to participate in the social network. There may be interest in identifying and reporting activities that “cheaters” use to gain undeserved credit, and to develop a cheat-resistant activity models. Model upgrades may be encouraged to allay allegations of such cheating in goal attainment competitions, for example. Further, users may compete for the reputation of the most prolific contributor of examples, the contributor of most interesting examples, best described problem, most insightful feedback, or funniest examples.

In an ecosystem with multiple model developers, models, and entities distributing models, any or all may compete for the best (e.g., in terms of accuracy) reputation, or the like. Thus, for example, if the model version 2.1 from company A has received a better reputation in the community, an achievement claim by a user on activity model version 2.1 from design company A is more trusted (and coveted) by users than the same claim from the device using a different activity model version 2.0 of design company B that has lower reputation. This reputational competition in the ecosystem motivates participation by the players, including user feedback and model developer innovation using that feedback. Additional examples and details are provided below.

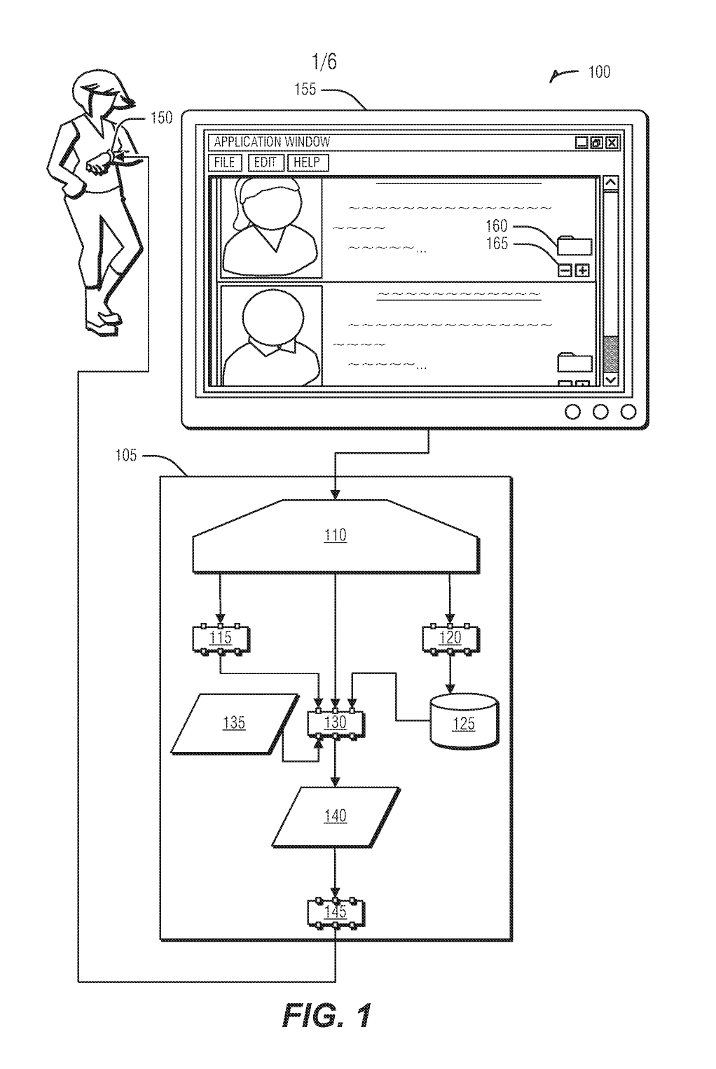

FIG. 1 is a block diagram of an example of an environment 100 including a system 105 for an embedded sensor model, according to an embodiment. The system 105 may include a multiplexer 110, a calculator 115, a data access object 120, a data store 125, a trainer 130, and a transceiver 145. The environment 100 may also include a user device 150 (e.g., a fitness wearable or the like) and a user interface 155 (here represented as an application on a tablet or a similar format). In operation, as illustrated, the system 105 may be communicatively coupled to the user interface 155 and the user device 150 via, for example, a wired or wireless network. Although the system 105 is illustrated in a single device, one or more of the system 105's components may be implemented in one or more other physical devices. For example, in a cloud computing environment, the actual hardware used for any given component implementation may be variable over time and space. Thus, the system 105 may be architecturally split between several physical devices and might include some elements within that run on the user device 150 or on a device that houses the user interface 155.

The multiplexer 110 may be arranged to obtain (e.g., receive or retrieve) a message that includes a model identifier field, a performance label, a sensor set, and a first user identification field containing a user identification. Here, the sensor set is a collection of sensor readings originating from the user device 150. The user identification uniquely identifies a particular user. Such identification may take one or more forms, such as a username, digital certificate, device identification (e.g., when the user device 150 is uniquely associated with a user), or the like. The sensor set is a collection of sensor data from a device with an activity sensor array (e.g., one or more of an accelerometer, a pyrometer, a barometer, a positioning system (e.g., satellite based geographical positioning system such as the global positioning system), heart monitor, conductivity monitor, etc.). The sensor set may include raw sensor data that may be split, for example, by the producing sensor elements (e.g., the accelerometers' data is separated from the barometer's data). In an example, the sensor data may be normalized or quantized prior to being included in the sensor set.

The performance label is a user selected classification of model performance. In an example, the performance label is free form (e.g., a textual description of the model performance by the user). In an example, the performance label is a user selection from a discrete list of performance labels. In an example, the performance label may include multiple elements. For example, the user may be prompted to select between a discrete list of initial label types (e.g., performance was good, performance indicates a false positive for activity, performance indicates a false negative for activity, etc.). The user interface 155 may then provide additional opportunities for the user to add additional fields (e.g., text or selected from a second list, etc) to clarify the initial label.

In an example, the performance label indicates that a model misclassified an activity. Misclassification represents a discrepancy between the actual user activity performed and the model results (e.g., indicating that the user was running whilst driving on a bumpy road). In an example, the misclassification is a false positive indication that the activity occurred. In an example, the misclassification is a cheat. Such a cheat may include, for example, the model indicating running whilst the user simply shakes her hand up and down. In this example, the one or more activities identified by a new model (see below) correspond the cheat. For example, the new model is trained to identify arm shaking as such, or as simply an attempt to simulate running while not actually running.

The multiplexer 110 may also be arranged to obtain a set of feedback packages. Here, the feedback packages are feedback data structures obtained from other users regarding one or more of the user, the user's message, the model, the sensor set, or other aspects of the user's original feedback. This meta-analysis of the user's shared information is used later to train the new model. In an example, a member of the set of feedback packages includes a value and a second user identification field containing the user identification. That is, a feedback package both identifies the user as well as provides a value. In an example, the set of feedback packages are obtained from a user interface 155. An example, of the user interface may be a forum or message board where users may form a community to discuss and share data related to the device 150, the model, a model developer, or other related topics. In an example, user interface 155 includes identification of a user corresponding to the user identification. For example, as illustrated, the top entry post includes a picture of the user. In an example, the user interface 155 includes a share interface element 160. This element permits the user to associate the sensor set to the performance label and themselves when, for example, authoring the post.

In an example, the user interface 155 also includes a value entry user interface element 165. The value entry user interface element 165 is presented to other user's viewing the post. The value entry user interface element 165 allows these other users to rate the post, the user, or the sensor set. In an example, the value entry user interface element 165 is a non-numeric graphical element with values assigned to a finite number of states (e.g., good, neutral, bad, very bad, etc.). In an example, the finite number of states 165 are two, one of the finite number of states corresponding to a positive and another of the finite number of states corresponding to a negative (e.g., as shown one may indicate a positive or negative result).

The calculator 115 may be arranged to aggregate values from members of the set of feedback packages to create a weight for the user identification. For example, as the feedback packages are obtained by the system, the calculator 115 tallies the positive votes and subtracts the negative votes to arrive at a weight corresponding to an aspect of the user's post. In an example, the calculator 115 is arranged to perform a histogram analysis of cumulative scoring feedback for the user. In this example, the result of the histogram analysis is used by the calculator 115 to assign an overall user weight (e.g., merit score) that weights the importance of that user's performance label.

The data access object 120 may be arranged to update a training set with the sensor set. The data access object 120 interfaces with the data store 125 (e.g., database, library, filesystem, disk, memory, etc.) in which activity data is kept. In an example, the activity data is tagged with a device version, activity being demonstrated, a confidence value corresponding to the sensor data, or other metadata to index the activity data. The data access object 120 includes software to update (e.g., add or modify) this activity data (e.g., training set) with the sensor set.

The trainer 130 may be arranged to apply the training set to a model 135 to create a new model 140. In an example, the trainer 130 may comprise a plurality of processing elements allowing for great parallelism in enacting the training. In applying the training set to the model 135, the trainer 130 implements a training technique whereby the training set applied to the model 135. The result is compared to a desired result and the model 135 is modified to create the new model 140. In a supervised training technique, a model correction (e.g., back propagation applied to an artificial neural network) may be explicit. In an unsupervised technique, generally, the model 135 modifies itself to have the output conform to a probability distribution present in the training set. In general, however, the performance label accompanying the sensor set will identify how the data is treated during training. For example, if the performance label indicates a false positive result, the sensor set may be treated as a contrary example of good performance away from which the model 135 will be trained.

In an example, the training includes modifying model training with respect to the sensor set based on the performance label and also the weight. In this example, the impact of the sensor set, or whether to even include the sensor set in the training, is based on the weight. Thus, if a user is deemed to have a low reputation (and thus a low or negative weight) the sensor set may be given less credence (e.g., the training will emphasize conforming to or away from depending on the performance label) to the sensor set. In an example, the model 135 used to create the new model 140 corresponds to the model identifier field. In a contra example, the model 135 may be a later version of the model identified by the identifier field.

The transceiver 145 may be arranged to transmit the new model 140 to the user device 150. Here, the new model 140 provides a sensor classifier for a sensor, or sensor array, monitoring user activity. A classifier is a type of model that produces a classification for its inputs. For example, if the inputs are a raster array of pixels produced via a stylus on a screen, the classifier may produce a letter of the alphabet, thus classifying the inputs to an output. The sensor classifier identifies one or more activities corresponding to the performance label and a model identified by the model identifier field. The sensor classifier may include a software classifier, a firmware update, or a programmable hardware definition (e.g., for a field programmable gate array) unit. In an example, the user device may include a pattern matching hardware engine. The sensor classifier may define the sought-after patterns that are applied by the hardware to sensor data. In an example, the pattern matching engine is implemented via a parallelized collection of hardware elements that each match a single pattern. In an example, the collection of hardware elements implement an associative array, the sensor data samples providing keys to the array when a match is present.

In an example, the system 105 may also include a search engine (not pictured) arranged to identify the user device via an association with a second user identification. This association may include common interests (e.g., participation in a sport or activity, etc.), common demographic information (e.g., age, race, gender, family, etc.), or other associative factors (e.g., expressed interest in a topic). In an example, the second user identification is obtained from matching a profile corresponding to the second user identification and a request. In an example, the request corresponds to the performance label and includes the user identification. In an example, the matching includes the search engine to find a correlation between sensor data of the profile and the training set. In an example, the matching includes the search engine to rank the new model and other models using feedback on at least one of model performance or model provider performance, the new model ranking higher than other models. In an example, the model performance of model provider performance are aggregates of values obtained from a ranking user interface.

The system 105 may enable a service tied to social network that allows suggestion of examples from the users (e.g., crowd sourcing) to gather additional labeled data for development of more general models. An example ingestion service may include facilities to upload data from the device, upload additional information such as text, picture, and videos from a message or from a post describing the operational conditions, correct (expected) classification and classification by the model, consent or release forms to use the data for improving the model. Thus, the system 105 underpins an ecosystem with model developer entities who use the crowd sourced data to build models that address the conditions reported by the users. These may be different or the same actors who deliver the HW platform.

In an example, these services may distribute models to some or all of the users. In an example, the distribution may be limited or given preferred treatment to those who contributed to the enhancement of the model. Additionally, the service may modify feedback or the feedback forum so as to manifest “achievements” measured by the device publicly or from a restricted network (e.g., group of friends). These achievements may be an aspect of a gamification service that provides motivation for user participation. Other gamification aspects may include a scoreboard and leaderboard, badges and ribbons, points and levels, etc.

Additionally, the request discussed above may also include a request to create a new model and, perhaps, specific a starting model or group of model developers to create the new model. Such requests, much like the user rating or model rating discussed herein, may also be rated by the user community to provide automatic selection of sensor data (e.g., new data to represent badminton) or even to prioritize model development.

As described above, the system 105 facilitates improving embedded sensor models via a user feedback platform that automatically connects even casual user feedback to developer systems to produce new models improving on activity monitoring. The system 105 reduces resource allocation by developers both on initial model production (e.g., because the model will rapidly improve if it is not great) as well as on updates (e.g., to correct previous model deficiencies, to recognize new activities, etc.).

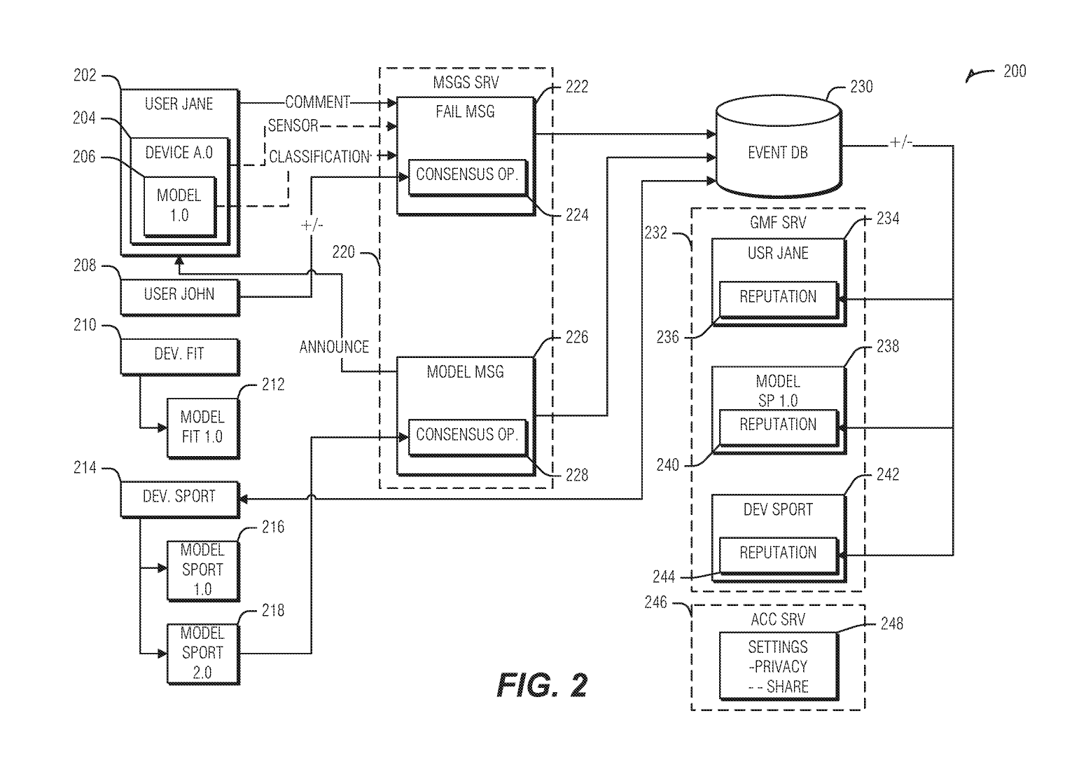

FIG. 2 illustrates a block diagram of an example of a system 200 for an embedded sensor model, according to an embodiment. Jane 202 has a device A.0 (e.g., smart wearable device) that includes a model 1.0 for a given activity (e.g., tennis). The hardware platform of a smart wearable device 204 includes appropriate sensors (e.g., an accelerometer, gyrometer, barometer, radio positioning system, etc.), and is possibly environmentally sealed for usage for sports, water sports, or other activities. The smart device 204 may connect to the web service (e.g., message service 220) to upload sensor and classification data (e.g., in the form of a fail message 222, feedback package, etc.). The hardware platform may also download firmware updates of models or upload of new models (e.g., from the message service 220 via a model message 226).

Communications may pass through the system 200 as follows. Developer Sport 214 releases the simplistic model SP v1.0 216 for a device platform (e.g., device A.0 implements such a platform). User Jane 202 owns one of these devices 204 loaded with version 1.0 of the SP model 206 and uncovers a shortcoming of the device-model 206 during use. Jane 202 and posts her finding 222 in the social network using the messaging service 220 to report and collect information. Jane 202 may also report that the device 204 has failed, perhaps not even knowing that the device-model 206 is to blame. In this example, the correlation between the report and both the device 204 and device-model 206 may be addressed by the backend based on the data shared by Jane 202.

When Jane 202 posts the message 222 reporting how the device 204 fails to recognize her running under certain conditions the information in her post 222 is collected in the event database 230 because Jane 202 has allowed the use of her information for model development through user account settings 248 in an account service 246.

The example provided updates Jane's reputation as a contributor and Sport's reputation as a developer and SPv1.0's reputation as a model (e.g., in the consensus opinion or feedback package 224). User John 208 sees Jane's post 222 and corroborates (+) or disputes (−) Jane's report. This interaction also updates the reputation of the event reported and Jane's reputation 236 (e.g., in the gamification service 232). In an example, John's reputation (e.g., as a collaborator) may also be tracked and updated. As illustrated, the gamification service 232 includes data structures to represent Jane 232 and her reputation 236, the Model SP 1.0 238 and its reputation 240, and Developer Sport 242 and its reputation 244.

Sport 214 is able to request the sensor data and the description of the operational conditions in which the examples (e.g., sensor samples) were collected. This request may also provide access to the original message 222 that may contain video, audio, comments, from Jane 202 in addition to the data provided by the device 204. The returned data includes Jane's, or the message's reputation to allow Sport 214 to take into consideration the reputation of the examples for inclusion in the model development.

As the examples from posts accumulate in the database 230, Sport 214 is able to create the improved model SPv2.0 218. Sport 214 announces the release of SPv2.0 218 through model release message 226 of the message service 220. This model message 226 may trigger the creation of a persona for the model (e.g., similar to the Model SP 1.0 persona 238) with its own reputation associated to the reputation of persona 242 of Sport 214. In an example, the model message 226 may also include a request for the message service 220 to contact the users (e.g., Jane 202 or John 208) who contributed with examples and inform them that a new model was released that incorporate the feedback that they provided.

Jane 202 may download the new version of the model. This cycle of model use, feedback, and improvement may motivate Jane 202 to continue to test the models and contribute feedback. Although the above discussion focused on Sport 214, additional developers, such as Fit 210 may compete with Sport 214 via the system 200 with their own models (e.g., FIT 100 212).

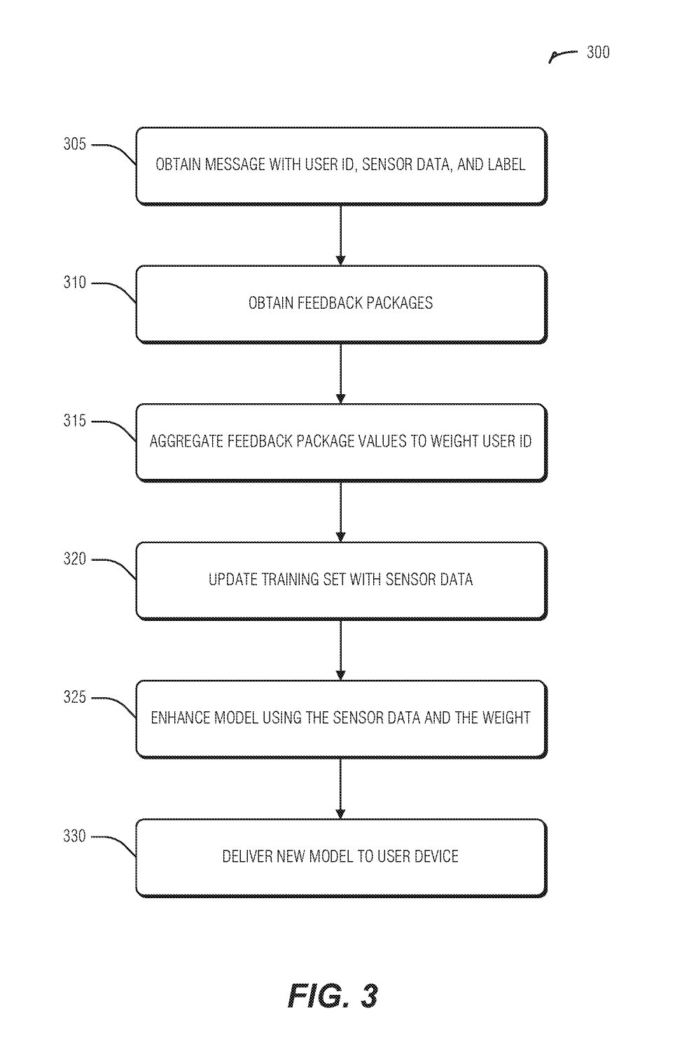

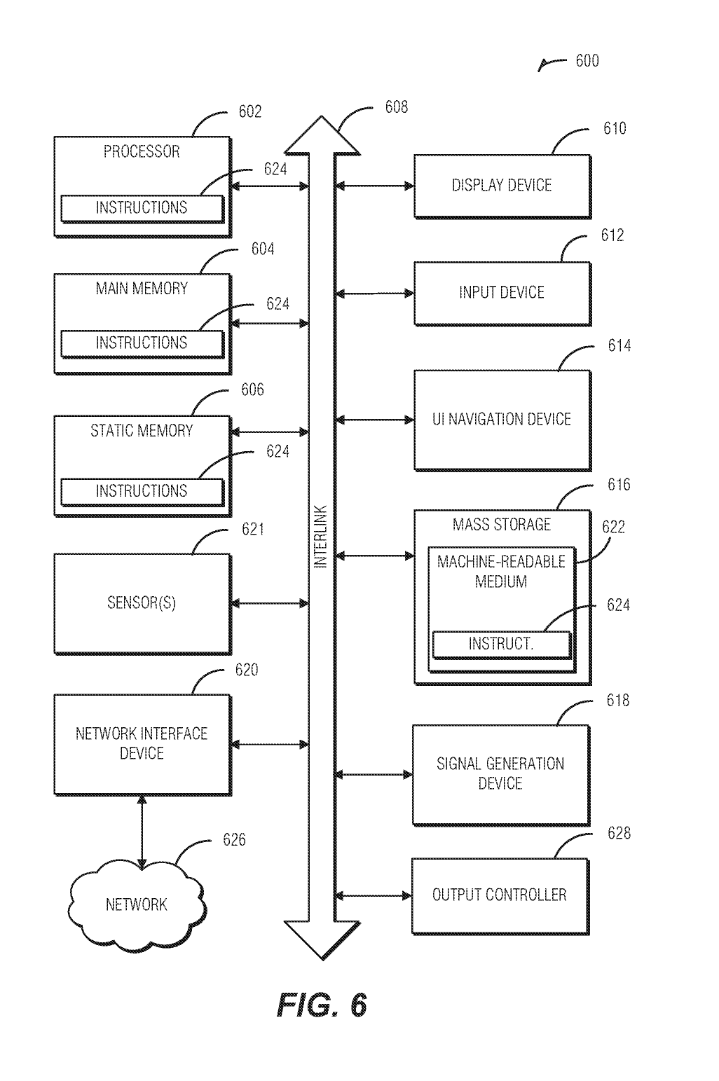

FIG. 3 illustrates a flow diagram of an example of a method for an embedded sensor model, according to an embodiment. The operations of the method 300 are performed by computer hardware, such as that described above, or below (e.g., circuitry as described with respect to FIG. 6).

At operation 305 a message that includes a model identifier field, a performance label, a sensor set, and a first user identification field containing a user identification may be obtained. In an example, the performance label indicates that a model misclassified an activity. In an example, a misclassification is a false positive indication that the activity occurred. In an example, the misclassification is a cheat. In this example, the one or more activities corresponding to the performance label identified by the classifier is the cheat.

At operation 310 a set of feedback packages may be obtained. A member of the set of feedback packages includes a value and a second user identification field containing the user identification. In an example, the set of feedback packages are Obtained from a user interface. In an example, the user interface includes identification of a user corresponding to the user identification.

In an example, the user interface also includes a value entry user interface element. In an example, the value entry user interface element is a non-numeric graphical element with values assigned to a finite number of states. In an example, the finite number of states are two, one of the finite number of states corresponding to a positive and another of the finite number of states corresponding to a negative.

At operation 315 values from members of the set of feedback packages are aggregated to create a weight for the user identification.

At operation 320 a training set is updated with the sensor set.

At operation 325 the training set is applied to a model to create a new model. This may include modifying model training with respect to the sensor set based on the performance label and the weight. In an example, the model used to create the new model corresponds to the model identifier field.

At operation 330 the new model is transmitted to a user device. In an example, the new model provides a sensor classifier for a sensor monitoring user activity. In an example, the sensor classifier identifies one or more activities corresponding to the performance label and a model identified by the model identifier field.

In an example, transmitting the new model to the user device includes identifying the user device via an association with a second user identification. The second user identification is obtained from matching a profile corresponding to the second user identification and a request. In an example, the request corresponds to the performance label and includes the user identification. In an example, the matching includes finding a correlation between sensor data of the profile and the training set. In an example, the matching includes ranking the new model and other models using feedback on at least one of model performance or model provider performance, the new model ranking higher than other models. In an example, the model performance of model provider performance are aggregates of values obtained from a ranking user interface.

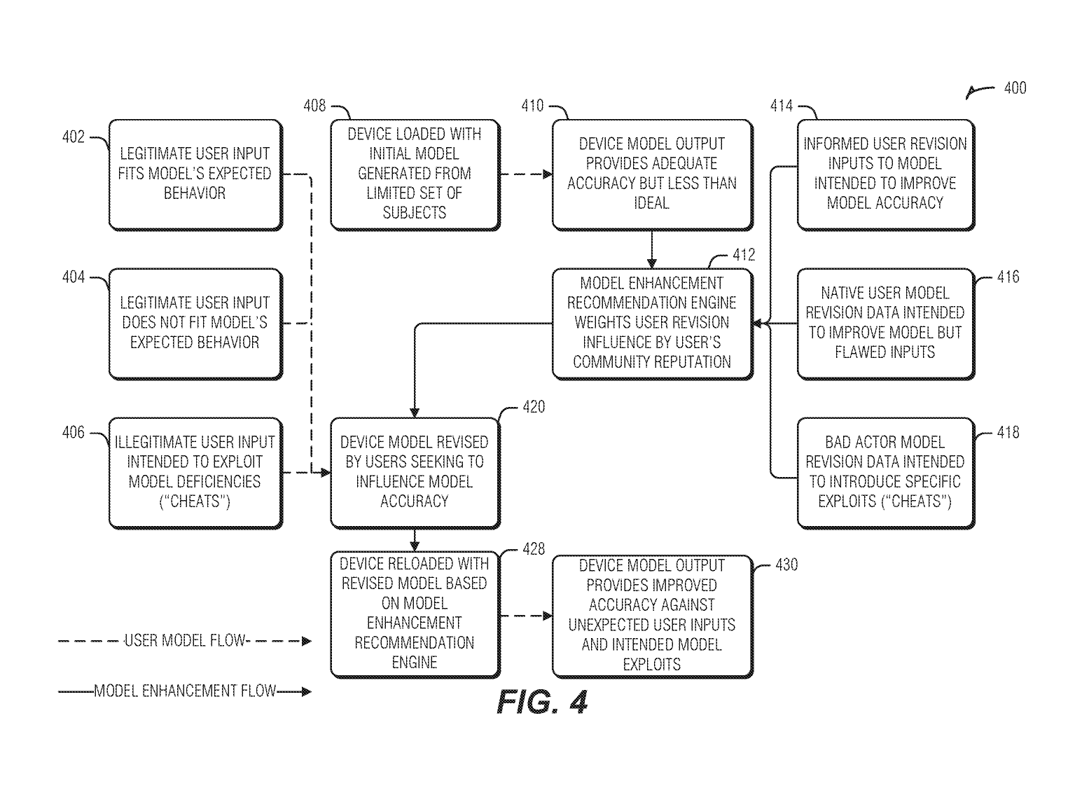

FIG. 4 illustrates a flow diagram of an example of a method 400 for an embedded sensor model, according to an embodiment. The operations of the method 400 are performed by computer hardware, such as that described above, or below (e.g., circuitry as described with respect to FIG. 6).

The method 400 may begin with an initial model embedded in a user device (e.g., operation 408). The user may use this model and notice that the performance could stand improvement (e.g., operation 410). The model itself may be subject to a developer initiated improvement cycle (e.g., operation 412) that integrates additional models for a variety of circumstances (e.g., operations 414, 416, and 418). These additional model operations may be trained with the user feedback (e.g., operations 402, 404, and 406) gathered by the system. The original model is revised in accordance with the user feedback, user reputation, and the model enhancement operations (e.g., operation 420). A user device may then be reloaded with the new model (e.g., operation 428) and used to produce an enhanced output (e.g., operation 430) of the user device with respect to one or more activities.

Improved feedback from users illustrated in FIG. 4 shows the direct channel of feedback provided by the present technique. Feedback from the users is uploaded with sensor data from the devices and organized for consumption by the developers. The reputation of the users reporting issues and requesting model updates is weighted by their reputation in the platform. The developer has access to the sensor data, device information, model revision information, conditions reported by the user and by the device, and reputation of the user reporting the example to decide when to collect new data, and which data to use, or how to use (e.g., weight), to build a new model. The new model is released, and feedback specific to this model may monitored through the platform because examples come with the version of the model used.

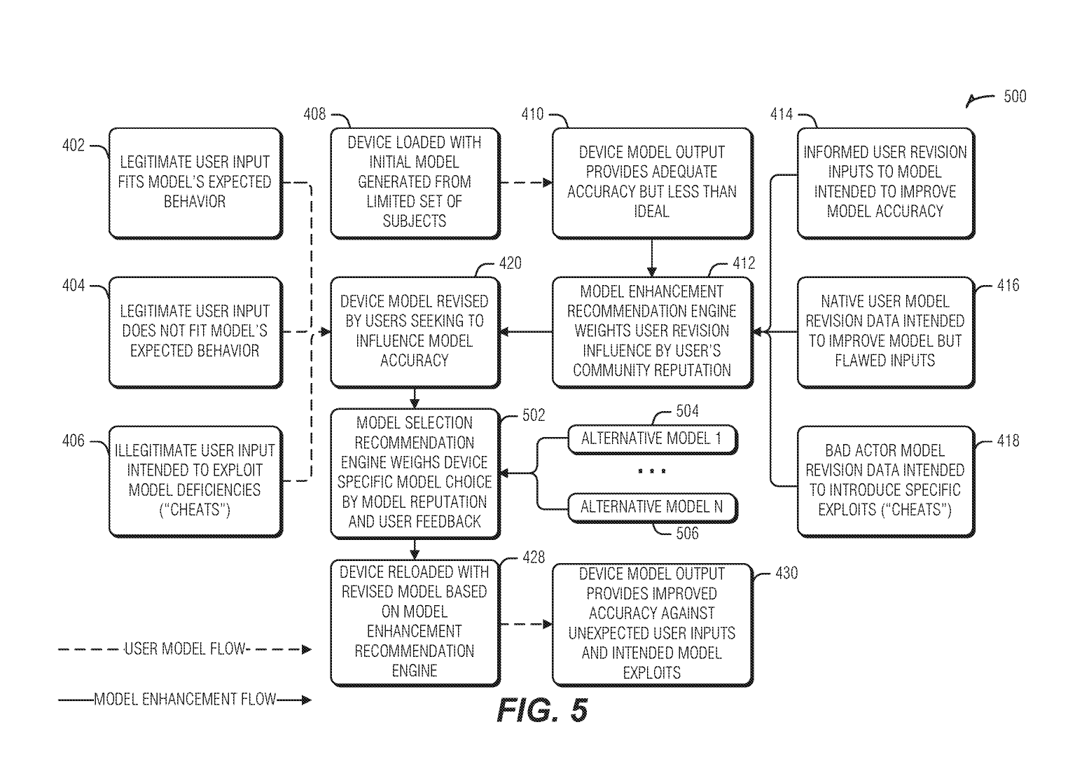

FIG. 5 illustrates a flow diagram of an example of a method for an embedded sensor model, according to an embodiment. The operations of the method 500 are performed by computer hardware, such as that described above, or below (e.g., circuitry as described with respect to FIG. 6). The method 500 primarily follows that described above with respect to the method 400, but is modified to provide model feedback between alternative models that may themselves be ranked via community reputation. Specifically, the system may deliver (e.g., operation 428) only one of several alternative models (e.g., developed in operations 504 through 506). The selection of which model to deliver is made based on, for example, a reputation score of the model itself, a developer of the model, or a distributor of the model (e.g., operation 502).

In an example, users may be presented with a ranking of the alternative models in operation 502. Personalization of models for each user allows the user to decide among the multiple models released which one is the one most likely to satisfy the user based on the reputation of the model, the developer, or fixes for issues reported by the user or issues and conditions that the user reported as relevant or important. The developer may develop multiple models each solving different subsets of reported issues with conditions or users to keep the models small and efficient. The service may make model recommendations to each user based on which issues the model was designed to improve.

The systems 105 and 200 as well as the methods 300, 400, and 500 permit the following use cases. A model developer (who may be the device developer or social network provider acting as a model creator) may release a racquet sports activity model for a sports and fitness bracelet that was developed using a small data set collected from a mix of racquet sports. A user of the device plays tennis and the device recognizes only half the time he played. He notices that the model did not give him credit when he practiced volleys. The users posts in the social network the poor quality of the device with a description of the conditions of the poor performance (e.g., a performance label), and maybe even includes a video poking fun of the device failing to recognize the user volleying.

Unlike current techniques in which these reports only generate negative publicity for the device, the present system and techniques enables the user to also associate the sensor readings to the post and a request to improve the model to cover this use case, with consent (e.g., permission) to use the data to enhance the model. The existence of instances of poor performance was expected by the model developers because the model was developed with “just enough” data to recognize the activities under a limited set of conditions and was not extensively tested to prevent misrecognition of other activities as playing racquet sports. However, the developer is able to analyze the data gathered from users' reports and may optionally reproduce the conditions reported and collect additional data.

The developer may give a “thumbs up” to the users that provided detailed descriptions of the examples and good quality data. Other users may also give “thumbs up” because they experienced the same problem or for the entertainment value of seeing the device failing. Users will report interesting cases to compete for a better reporter reputation. As the ratings of the users reporting examples and the ratings to the posting of the example accumulate, the expected usefulness of the user's examples may be weighted by the ratings of the user and of the example.

After enhancing the model to correctly recognize a tennis player volleying, the developer releases an enhanced model to the platform. The developer also asks for a special release message to all users of the device and a special message for all users that reported issues fixed in this model. Users may give “thumbs up” for developers that deliver enhanced models that fix the reported problems.

As more examples of classification accumulate, the developer uses the richer data set to improve the general racquet sports identifier from inferences like “you spent one hour doing some form of racket sport” into a model that identifies a specific racquet sports such as court tennis, stickle tennis, platform tennis, table tennis, pickle ball, badminton, squash, racquetball, etc. The model may be more specific such as classifying an activity to “you played one hour of badminton” or into multiple models, one for each sport, such as a more accurate badminton model or a richer and more specific tennis model (e.g., “you played one hour of tennis, fifteen minutes practicing volleys, forty five minutes practicing baseline strokes”, etc.).

Another model may also be released to measure running distances and speeds by counting steps. The platform enables users to use their device to report the runs and compete with their running buddies for “most impressive runner,” for example. As a joke, one of the users spends an hour flexing his arm while sitting at his desk at work to report an amazingly long and fast run. One of his buddies finds out how the device was tricked, reproduces the conditions and reports the “cheat” as an example of the device incorrectly recognizing running. Again, an improved model is released that does not credit this activity as running (e.g., correcting for false positives) or other sensor readings that are not examples of running. The running buddies ask the cheater to update his device with the new model and repeat the prior feat for validation.

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### Additional Notes & Examples

Example 1 is a system for updating an embedded model, the system comprising: a multiplexer to: obtain a message that includes a model identifier field, a performance label, a sensor set, and a first user identification field containing a user identification; and obtain a set of feedback packages, a member of the set of feedback packages including a value and a second user identification field containing the user identification; a calculator to aggregate values from members of the set of feedback packages to create a weight for the user identification; a trainer to apply a training set to a model to create a new model, the applying including modifying model training with respect to the sensor set based on the performance label and the weight; and a transceiver to transmit the new model to a user device, the new model providing a sensor classifier for a sensor monitoring user activity.

In Example 2, the subject matter of Example 1 optionally includes wherein the model used to create the new model corresponds to the model identifier field.

In Example 3, the subject matter of any one or more of Examples 1-2 optionally include wherein the performance label indicates that a model misclassified an activity.

In Example 4, the subject matter of Example 3 optionally includes wherein a misclassification is a false positive indication that the activity occurred.

In Example 5, the subject matter of Example 4 optionally includes wherein the misclassification is a cheat, wherein the sensor classifier identifies one or more activities corresponding to the performance label and a model identified by the model identifier field, and wherein the one or more activities corresponding to the performance label identified by the classifier is the cheat.

In Example 6, the subject matter of any one or more of Examples 1-5 optionally include wherein the set of feedback packages are obtained from a user interface, the user interface including: identification of a user corresponding to the User identification; and a value entry user interface element.

In Example 7, the subject matter of Example 6 optionally includes wherein the value entry user interface element is a non-numeric graphical element with values assigned to a finite number of states.

In Example 8, the subject matter of Example 7 optionally includes wherein the finite number of states are two, one of the finite number of states corresponding to positive feedback and another of the finite number of states corresponding to negative feedback.

In Example 9, the subject matter of any one or more of Examples 1-8 optionally include a search engine to identify the user device via an association with a second user identification, the second user identification obtained from matching a profile corresponding to the second user identification and a request.

In Example 10, the subject matter of Example 9 optionally includes wherein the request corresponds to the performance label and includes the user identification.

In Example 11, the subject matter of any one or more of Examples 9-10 optionally include wherein the matching includes the search engine to find a correlation between sensor data of the profile and the training set.

In Example 12, the subject matter of any one or more of Examples 9-11 optionally include wherein the matching includes the search engine to rank the new model and other models using feedback on at least one of model performance or model provider performance, the new model ranking higher than other models.

In Example 13, the subject matter of Example 12 optionally includes wherein the model performance of model provider performance are aggregates of values obtained from a ranking user interface.

Example 14 is a method for updating an embedded model, the method comprising: obtaining a message that includes a model identifier field, a performance label, a sensor set, and a first user identification field containing a user identification; obtaining a set of feedback packages, a member of the set of feedback packages including a value and a second user identification field containing the user identification; aggregating values from members of the set of feedback packages to create a weight for the user identification; applying a training set to a model to create a new model, the applying including modifying model training with respect to the sensor set based on the performance label and the weight; and transmitting the new model to a user device, the new model providing a sensor classifier for a sensor monitoring user activity.

In Example 15, the subject matter of Example 14 optionally includes wherein the model used to create the new model corresponds to the model identifier field.

In Example 16, the subject matter of any one or more of Examples 14-15 optionally include wherein the performance label indicates that a model misclassified an activity.

In Example 17, the subject matter of Example 16 optionally includes wherein a misclassification is a false positive indication that the activity occurred.

In Example 18, the subject matter of Example 17 optionally includes wherein the misclassification is a cheat, wherein the sensor classifier identifies one or more activities corresponding to the performance label and a model identified by the model identifier field, and wherein the one or more activities corresponding to the performance label identified by the classifier is the cheat.

In Example 19, the subject matter of any one or more of Examples 14-18 optionally include wherein the set of feedback packages are obtained from a user interface, the user interface including: identification of a user corresponding to the user identification; and a value entry user interface element.

In Example 20, the subject matter of Example 19 optionally includes wherein the value entry user interface element is a non-numeric graphical element with values assigned to a finite number of states.

In Example 21, the subject matter of Example 20 optionally includes wherein the finite number of states are two, one of the finite number of states corresponding to positive feedback and another of the finite number of states corresponding to negative feedback.

In Example 22, the subject matter of any one or more of Examples 14-21 optionally include wherein transmitting the new model to the user device includes identifying the user device via an association with a second user identification, the second user identification obtained from matching a profile corresponding to the second user identification and a request.

In Example 23, the subject matter of Example 22 optionally includes wherein the request corresponds to the performance label and includes the user identification.

In Example 24, the subject matter of any one or more of Examples 22-23 optionally include wherein the matching includes finding a correlation between sensor data of the profile and the training set.

In Example 25, the subject matter of any one or more of Examples 22-24 optionally include wherein the matching includes ranking the new model and other models using feedback on at least one of model performance or model provider performance, the new model ranking higher than other models.

In Example 26, the subject matter of Example 25 optionally includes wherein the model performance of model provider performance are aggregates of values obtained from a ranking user interface.

Example 27 is at least one machine readable medium including instructions that, when executed by a machine, cause the machine to perform any of methods 14-26.

Example 28 is a system including means to perform any of methods 14-26.

Example 29 is a system for updating an embedded model, the system comprising: means for obtaining a message that includes a model identifier field, a performance label, a sensor set, and a first user identification field containing a user identification; means for obtaining a set of feedback packages, a member of the set of feedback packages including a value and a second user identification field containing the user identification; means for aggregating values from members of the set of feedback packages to create a weight for the user identification; means for applying a training set to a model to create a new model, the applying including modifying model training with respect to the sensor set based on the performance label and the weight; and means for transmitting the new model to a user device, the new model providing a sensor classifier for a sensor monitoring user activity.

In Example 30, the subject matter of Example 29 optionally includes wherein the model used to create the new model corresponds to the model identifier field.

In Example 31, the subject matter of any one or more of Examples 29-30 optionally include wherein the performance label indicates that a model misclassified an activity.

In Example 32, the subject matter of Example 31 optionally includes wherein a misclassification is a false positive indication that the activity occurred.

In Example 33, the subject matter of Example 32 optionally includes wherein the misclassification is a cheat, wherein the sensor classifier identifies one or more activities corresponding to the performance label and a model identified by the model identifier field, and wherein the one or more activities corresponding to the performance label identified by the classifier is the cheat.

In Example 34, the subject matter of any one or more of Examples 29-33 optionally include wherein the set of feedback packages are obtained from a user interface, the user interface including: means for identification of a user corresponding to the user identification; and a value entry user interface element.

In Example 35, the subject matter of Example 34 optionally includes wherein the value entry user interface element is a non-numeric graphical element with values assigned to a finite number of states.

In Example 36, the subject matter of Example 35 optionally includes wherein the finite number of states are two, one of the finite number of states corresponding to positive feedback and another of the finite number of states corresponding to negative feedback.

In Example 37, the subject matter of any one or more of Examples 29-36 optionally include wherein the means for transmitting the new model to the user device includes means for identifying the user device via an association with a second user identification, the second user identification obtained from matching a profile corresponding to the second user identification and a request.

In Example 38, the subject matter of Example 37 optionally includes wherein the request corresponds to the performance label and includes the user identification.

In Example 39, the subject matter of any one or more of Examples 37-38 optionally include wherein the means for matching includes means for finding a correlation between sensor data of the profile and the training set.

In Example 40, the subject matter of any one or more of Examples 37-39 optionally include wherein the means for matching includes means for ranking the new model and other models using feedback on at least one of model performance or model provider performance, the new model ranking higher than other models.

In Example 41, the subject matter of Example 40 optionally includes wherein the model performance of model provider performance are aggregates of values obtained from a ranking user interface.

Example 42 is at least one machine readable medium including instructions for updating an embedded model, the instructions, when executed by a machine, cause the machine to: obtain a message that includes a model identifier field, a performance label, a sensor set; and a first user identification field containing a user identification; and obtain a set of feedback packages, a member of the set of feedback packages including a value and a second user identification field containing the user identification; aggregate values from members of the set of feedback packages to create a weight for the user identification; apply a training set to a model to create a new model, the applying including modifying model training with respect to the sensor set based on the performance label and the weight; and transmit the new model to a user device, the new model providing a sensor classifier for a sensor monitoring user activity.

In Example 43, the subject matter of Example 42 optionally includes wherein the model used to create the new model corresponds to the model identifier field.

In Example 44, the subject matter of any one or more of Examples 42-43 optionally include wherein the performance label indicates that a model misclassified an activity.

In Example 45, the subject matter of Example 44 optionally includes wherein a misclassification is a false positive indication that the activity occurred.

In Example 46, the subject matter of Example 45 optionally includes wherein the misclassification is a cheat, wherein the sensor classifier identifies one or more activities corresponding to the performance label and a model identified by the model identifier field, and wherein the one or more activities corresponding to the performance label identified by the classifier is the cheat.

In Example 47, the subject matter of any one or more of Examples 42-46 optionally include wherein the set of feedback packages are obtained from a user interface, the user interface including: identification of a user corresponding to the user identification; and a value entry user interface element.

In Example 48, the subject matter of Example 47 optionally includes wherein the value entry user interface element is a non-numeric graphical element with values assigned to a finite number of states.

In Example 49, the subject matter of Example 48 optionally includes wherein the finite number of states are two, one of the finite number of states corresponding to positive feedback and another of the finite number of states corresponding to negative feedback.

In Example 50, the subject matter of any one or more of Examples 42-49 optionally include wherein the instructions cause the machine to identify the user device via an association with a second user identification, the second user identification obtained from matching a profile corresponding to the second user identification and a request.

In Example 51, the subject matter of Example 50 optionally includes wherein the request corresponds to the performance label and includes the user identification.

In Example 52, the subject matter of any one or more of Examples 50-51 optionally include wherein the matching includes the machine to find a correlation between sensor data of the profile and the training set.

In Example 53, the subject matter of any one or more of Examples 50-52 optionally include wherein the matching includes the machine to rank the new model and other models using feedback on at least one of model performance or model provider performance, the new model ranking higher than other models.

In Example 54, the subject matter of Example 53 optionally includes wherein the model performance of model provider performance are aggregates of values obtained from a ranking user interface.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc, are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for updating an embedded model, the system comprising:
a multiplexer to:
obtain a message that includes a model identifier field, a performance label, a sensor set, and a first user identification field containing a user identification; and
obtain a set of feedback packages, a member of the set of feedback packages including a value and a second user identification field containing the user identification;
a calculator to aggregate values from members of the set of feedback packages to create a weight for the user identification;
a trainer to apply a training set to a model to create a new model, the applying including modifying model training with respect to the sensor set based on the performance label and the weight; and
a transceiver to transmit the new model to a user device, the new model providing a sensor classifier for a sensor monitoring user activity.

2. The system of claim 1, wherein the model used to create the new model corresponds to the model identifier field.

3. The system of claim 1, wherein the performance label indicates that a model misclassified an activity.

4. The system of claim 3, wherein a misclassification is a false positive indication that the activity occurred.

5. The system of claim 4, wherein the misclassification is a cheat, wherein the sensor classifier identifies one or more activities corresponding to the performance label and a model identified by the model identifier field, and wherein the one or more activities corresponding to the performance label identified by the classifier is the cheat.

6. The system of claim 1, wherein the set of feedback packages are obtained from a user interface, the user interface including:
identification of a user corresponding to the user identification; and
a value entry user interface element.

7. The system of claim 1, comprising a search engine to identify the user device via an association with a second user identification, the second user identification obtained from matching a profile corresponding to the second user identification and a request.

8. The system of claim 7, wherein the matching includes the search engine to rank the new model and other models using feedback on at least one of model performance or model provider performance, the new model ranking higher than other models.

9. A method for updating an embedded model, the method comprising:
obtaining a message that includes a model identifier field, a performance label, a sensor set, and a first user identification field containing a user identification;
obtaining a set of feedback packages, a member of the set of feedback packages including a value and a second user identification field containing the user identification;
aggregating values from members of the set of feedback packages to create a weight for the user identification;
applying a training set to a model to create a new model, the applying including modifying model training with respect to the sensor set based on the performance label and the weight; and
transmitting the new model to a user device, the new model providing a sensor classifier for a sensor monitoring user activity.

10. The method of claim 9, wherein the model used to create the new model corresponds to the model identifier field.

11. The method of claim 9, wherein the performance label indicates that a model misclassified an activity.

12. The method of claim 11, wherein a misclassification is a false positive indication that the activity occurred.

13. The method of claim 12, wherein the misclassification is a cheat, wherein the sensor classifier identifies one or more activities corresponding to the performance label and a model identified by the model identifier field, and wherein the one or more activities corresponding to the performance label identified by the classifier is the cheat.

14. The method of claim 9, wherein the set of feedback packages are obtained from a user interface, the user interface including:
identification of a user corresponding to the user identification; and
a value entry user interface element.

15. The method of claim 9, wherein transmitting the new model to the user device includes identifying the user device via an association with a second user identification, the second user identification obtained from matching a profile corresponding to the second user identification and a request.

16. The method of claim 15, wherein the matching includes ranking the new model and other models using feedback on at least one of model performance or model provider performance, the new model ranking higher than other models.

17. At least one machine readable medium including instructions for updating an embedded model, the instructions, when executed by a machine, cause the machine to:
obtain a message that includes a model identifier field, a performance label, a sensor set, and a first user identification field containing a user identification; and
obtain a set of feedback packages, a member of the set of feedback packages including a value and a second user identification field containing the user identification;
aggregate values from members of the set of feedback packages to create a weight for the user identification;
apply a training set to a model to create a new model, the applying including modifying model training with respect to the sensor set based on the performance label and the weight; and
transmit the new model to a user device, the new model providing a sensor classifier for a sensor monitoring user activity.

18. The at least one machine readable medium of claim 17, wherein the model used to create the new model corresponds to the model identifier field.

19. The at least one machine readable medium of claim 17, wherein the performance label indicates that a model misclassified an activity.

20. The at least one machine readable medium of claim 19, wherein a misclassification is a false positive indication that the activity occurred.

21. The at least one machine readable medium of claim 20, wherein the misclassification is a cheat, wherein the sensor classifier identifies one or more activities corresponding to the performance label and a model identified by the model identifier field, and wherein the one or more activities corresponding to the performance label identified by the classifier is the cheat.

22. The at least one machine readable medium of claim 17, wherein the set of feedback packages are obtained from a user interface, the user interface including:
identification of a user corresponding to the user identification; and
a value entry user interface element.

23. The at least one machine readable medium of claim 17, wherein the instructions cause the machine to identify the user device via an association with a second user identification, the second user identification obtained from matching a profile corresponding to the second user identification and a request.

24. The at least one machine readable medium of claim 23, wherein the matching includes the machine to rank the new model and other models using feedback on at least one of model performance or model provider performance, the new model ranking higher than other models.
